(19) United States
(12) Patent Application Publication
(10) Pub. No.: US 2026/0106788 A1
(43) Pub. Date: Apr. 16, 2026

(54) SYSTEM AND METHOD FOR COMPUTER NETWORK EVENT DATA REDUNDANCY SUPPRESSION VIA INTEGRATED MACHINE LEARNING

(71) Applicant: BANK OF AMERICA CORPORATION, Charlotte, NC (US)

(72) Inventors: Dennis Vranjesevic, Kent Cliffs, NY (US); Tony Aidoo, Aubrey, TX (US); Pratap Dande, Saint Johns, FL (US); Noell Y. Eury, Stanfield, NC (US); Brian Jacobson, Granada Hills, CA (US); Rahul Yaksh, Austin, TX (US); Bojan Zdravkovic, Jersey City, NJ (US)

(73) Assignee: BANK OF AMERICA CORPORATION, Charlotte, NC (US)

(21) Appl. No.: 18/914,689

(22) Filed: Oct. 14, 2024

(51) Int. Cl. H04L 41/0604; H04L 41/0686

(52) U.S. Cl. CPC H04L 41/0613; H04L 41/0686

(57) ABSTRACT

Systems, computer program products, and methods are described herein for computer network event data redundancy suppression via integrated machine learning. The present disclosure includes receiving interaction data from at least one endpoint device of a plurality of endpoint devices, recording the interaction data in usage logs, determining a presence of an event in the usage logs using at least one log analysis platform, enriching, using a lookup command of a network event management system, the event to form at least one enriched event, transmitting the at least one enriched event to a first machine learning model, determining a presence of a fractional event based on the at least one enriched event, grouping the fractional event with related fractional events into an aggregate event, determining a target endpoint device group for transmitting the aggregate event, and transmitting the aggregate event to the target endpoint device group.

### TECHNOLOGICAL FIELD

Example implementations of the present disclosure relate to a system and method for computer network event data redundancy suppression via integrated machine learning.

### BACKGROUND

In large-scale IT infrastructure environments, where numerous systems and servers operate concurrently, maintaining the stability and functionality of these systems is a complex challenge. A significant issue arises from the generation of alerts triggered by various monitoring systems. These alerts, which can number in the millions daily, include both informational and actionable notifications. However, a substantial portion of these alerts are redundant, and create noise rather than providing valuable information. This redundancy results in multiple alerts being generated for the same event, which further exacerbates the problem. The current event management systems are inundated with non-qualified tickets—tickets that require review but often result in no action being taken. This inefficiency leads to a waste of time and resources for event management operations teams, who must sift through a vast number of irrelevant alerts to identify those that genuinely require attention.

### BRIEF SUMMARY

Systems, methods, and computer program products are provided for computer network event data redundancy suppression via integrated machine learning.

In one aspect, a system for computer network event data redundancy suppression via integrated machine learning is presented. The system may include a processing device, and a non-transitory storage device containing instructions, when executed by the processing device, the instructions cause the processing device to perform the steps of receiving interaction data from at least one endpoint device of a plurality of endpoint devices, recording the interaction data in usage logs, determining a presence of an event in the usage logs using at least one log analysis platform, enriching, using a lookup command of a network event management system, the event to form at least one enriched event, transmitting the at least one enriched event to a first machine learning model, determining, in real-time, using the first machine learning model, a presence of a fractional event based on the at least one enriched event, grouping, in real-time, upon a first condition where the first machine learning model determines the presence of the fractional event, the fractional event with related fractional events into an aggregate event, determining a target endpoint device group for transmitting the aggregate event, and transmitting the aggregate event to the target endpoint device group.

In some implementations, the instructions may further cause the processing device to perform the steps of transmitting, to a second machine learning model, the aggregate event, and determining, using the second machine learning model, the target endpoint device group.

In some implementations, the fractional event and the related fractional events are removed in favor of the aggregate event.

In some implementations, enriching the event may include temporal correlation and rule-based filtering.

In some implementations, the at least one log analysis platform is a plurality of log analysis platforms.

In some implementations, the aggregate event may include a notification including aggregate event details.

In some implementations, the instructions further cause the processing device to perform the steps of suppressing, in real time, a subsequent fractional event upon a condition where the aggregate event associated with the subsequent fractional event has been transmitted to the target endpoint device group.

In another implementation, a computer program product for computer network event data redundancy suppression via integrated machine learning is presented. The computer program product may include a non-transitory computer-readable medium having code causing an apparatus to receive interaction data from at least one endpoint device of a plurality of endpoint devices, record the interaction data in usage logs, determine a presence of an event in the usage logs using at least one log analysis platform, enrich, using a lookup command of a network event management system, the event to form at least one enriched event, transmit the at least one enriched event to a first machine learning model, determine, using the first machine learning model, a presence of a fractional event based on the at least one enriched event, group, upon a first condition where the first machine learning model determines the presence of the fractional event, the fractional event with related fractional events into an aggregate event, determine a target endpoint device group for transmitting the aggregate event, and transmit the aggregate event to the target endpoint device group.

In some implementations, the code further causes the apparatus to: transmit, to a second machine learning model, the aggregate event, and determine, using the second machine learning model, the target endpoint device group.

In some implementations, the fractional event and the related fractional events are removed in favor of the aggregate event.

In some implementations, enriching the event may include temporal correlation and rule-based filtering.

In some implementations, the at least one log analysis platform is a plurality of log analysis platforms.

In some implementations, the aggregate event may include a notification including aggregate event details.

In some implementations, the code further causes the apparatus to suppress, in real time, a subsequent fractional event upon a condition where the aggregate event associated with the subsequent fractional event has been transmitted to the target endpoint device group.

In yet another aspect, a method for computer network event data redundancy suppression via integrated machine learning is presented. The method may include receiving interaction data from at least one endpoint device of a plurality of endpoint devices, recording the interaction data in usage logs, determining a presence of an event in the usage logs using at least one log analysis platform, enriching, using a lookup command of a network event management system, the event to form at least one enriched event, transmitting the at least one enriched event to a first machine learning model, determining, using the first machine learning model, a presence of a fractional event based on the at least one enriched event, grouping, upon a first condition where the first machine learning model determines the presence of the fractional event, the fractional event with related fractional events into an aggregate event, determining a target endpoint device group for transmitting the aggregate event, and transmitting the aggregate event to the target endpoint device group.

In some implementations, the method may further include transmitting, to a second machine learning model, the aggregate event, and determining, using the second machine learning model, the target endpoint device group.

In some implementations, the fractional event and the related fractional events are removed in favor of the aggregate event.

In some implementations, enriching the event may include temporal correlation and rule-based filtering.

In some implementations, the at least one log analysis platform is a plurality of log analysis platforms.

In some implementations, the aggregate event may include a notification including aggregate event details.

The above summary is provided merely for purposes of summarizing some example implementations to provide a basic understanding of some aspects of the present disclosure. Accordingly, it will be appreciated that the above-described implementations are merely examples and should not be construed to narrow the scope or spirit of the disclosure in any way. It will be appreciated that the scope of the present disclosure encompasses many potential implementations in addition to those here summarized, some of which will be further described below.

### BRIEF DESCRIPTION OF THE DRAWINGS

Having thus described implementations of the disclosure in general terms, reference will now be made the accompanying drawings. The components illustrated in the Figures may or may not be present in certain implementations described herein. Some implementations may include fewer (or more) components than those shown in the Figures.

FIGS. 1A-1C illustrate technical components of an exemplary distributed computing environment for computer network event data redundancy suppression via integrated machine learning, in accordance with an implementation of the disclosure;

FIG. 2 illustrates an exemplary machine learning model subsystem architecture, in accordance with an implementation of the disclosure;

FIG. 3 illustrates a process flow for computer network event data redundancy suppression via integrated machine learning, in accordance with an implementation of the disclosure; and

FIG. 4 illustrates a flow diagram for computer network event data redundancy suppression via integrated machine learning, in accordance with an implementation of the disclosure.

### DETAILED DESCRIPTION

Implementations of the present disclosure will now be described more fully hereinafter with reference to the accompanying drawings, in which some, but not all, implementations of the disclosure are shown. Indeed, the disclosure may be implemented in many different forms and should not be construed as limited to the implementations set forth herein; rather, these implementations are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the entity, its products or applications, the customers or any other aspect of the operations of the entity. As such, the entity may be any institution, group, association, financial institution, establishment, company, union, authority or the like, employing information technology resources for processing large amounts of data.

As described herein, a “user” may be an individual associated with an entity. As such, in some implementations, the user may be an individual having past relationships, current relationships or potential future relationships with an entity. In some implementations, the user may be an employee (e.g., an associate, a project manager, an IT specialist, a manager, an administrator, an internal operations analyst, or the like) of the entity or enterprises affiliated with the entity.

As used herein, a “user interface” or “display” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. An engine may be self-contained, but externally controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some implementations, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system. In some implementations, an engine may implement a machine learning model to perform functions as a foundation for the larger piece of software that drives the functionality of the software. The machine learning model for any given engine may be self-contained (e.g., without interaction with other engines), or the machine learning model may be shared across one or more engines. In other words, some implementations of the larger piece of software many implement multiple machine learning models to perform functions of the various engines. In other implementations, a single machine learning model may be shared across one or more engines to perform the functions attributed thereto as described herein.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that an element matches a predetermined criterion, including that a threshold has been met, passed, exceeded, and so on.

As used herein, a “log analysis platform” may refer to a platform designed to collect, index, and analyze log data from various sources, such as servers, applications, and network devices, to provide real-time insights, problem-solving capabilities, and monitoring of system performance and security. These platforms often use search and reporting functionalities, and allow users to identify patterns, detect anomalies, and generate actionable intelligence.

As used herein, a “network event management system” may refer to a platform or suite of tools designed for real-time monitoring, event correlation, and fault management across IT and telecommunications networks. This system is capable of integrating with various network components to detect, prioritize, and respond to events or issues in the network. The network event management system outputs event alerts, notifications, event logs and reports, dashboards and visualizations, automated response actions, incident tickets.

A log analysis platform and a network event management system may work in tandem to provide comprehensive oversight and management of IT environments. The log analysis platform may aggregate and processes log data from various systems, including those monitored by the network event management system. In turn, the network event management system may correlate network events with the logs collected by the log analysis platform to allow for analysis and contextual understanding of incidents.

In modern IT environments characterized by a large number of interconnected systems and servers, the monitoring and alerting processes are critical for maintaining operational stability. However, these processes suffer from a significant technical issue related to alert generation and event correlation. Specifically, the monitoring systems generate an excessive volume of alerts—often exceeding millions daily—that encompass both informational and actionable data. This flood of alerts is compounded by the fact that many are redundant, resulting in multiple alerts for the same underlying event. The lack of effective correlation mechanisms leads to the creation of non-qualified tickets in event management systems. These tickets, generated from raw alert data, are predominantly noise and do not accurately reflect actionable incidents, thereby overwhelming event management teams with irrelevant information and impeding their ability to efficiently manage and resolve genuine issues.

Current solutions for managing alert generation and event correlation are inadequate in addressing the technical problem of alert noise and redundancy. Existing monitoring systems and event management platforms rely heavily on basic filtering and threshold mechanisms, which are inadequate for distinguishing between informational alerts and those requiring immediate action. Additionally, these systems lack robust correlation algorithms capable of aggregating related alerts into a single, meaningful incident report. As a result, they generate a high volume of non-qualified tickets, which require manual review by event management teams. This manual process is time-consuming and error-prone, leading to operational inefficiencies and a significant waste of resources. The inability of these systems to effectively reduce noise and accurately prioritize critical alerts undermines the overall robustness and responsiveness of IT operations, leaving the underlying technical problem unresolved.

Addressing these challenges requires the establishment of a system and method for computer network event data redundancy suppression via integrated machine learning, which provides for the implementation of a machine learning model to predict (i.e., determine) groupings of events that are related to one another in root cause, and in doing so eliminate redundancies of events being transmitted to endpoint devices for disposition. This determination results in reducing overall noise in the number of events of the system, allowing the appropriate resources to be allocated to events that are higher in priority without having to manually filter through redundant or immaterial (i.e., non-important or less-than-important) events.

To do so, interaction data from endpoint devices may be received and recorded into usage logs. One or more log analysis platforms may be used to determine a presence of an event in the usage logs. Using a lookup command of a network event management system, the event may be enriched, which may include temporal correlation and rule-based filtering. The enriched event(s) may then be provided to a machine learning model. Using this machine learning model, the system may determine if a fractional event is present, where the fractional event determination is based on the enriched event. If fractional events are identified, similar fractional events may be grouped in a group, upon a first condition where the first machine learning model determines the presence of the fractional event, the fractional event with related fractional events into an aggregate event. The fractional event and the related fractional events may then be removed in favor of the aggregate event. Based on the aggregate event, a target endpoint device group for transmitting the aggregate event may then be determined, which can occur via lookup or via another machine learning model, and the aggregate event may be transmitted to the target endpoint device group. This may include a notification with details regarding the aggregate event. A subsequent fractional event may be suppressed in real-time if the aggregate event associated with the subsequent fractional event has already been transmitted to the target endpoint device group.

What is more, the present disclosure provides a technical solution to a technical problem. As described herein, the technical problem includes the generation of excessive, redundant alerts in modern IT environments, lacking effective correlation mechanisms, which results in non-actionable tickets overwhelming event management teams and hindering efficient issue resolution. The present disclosure embraces an improvement over existing solutions by allowing for the improvement in efficiency of computing resource usage (i) with fewer steps to achieve the solution (e.g., implementing a machine learning model to route events to the appropriate endpoint devices and groups overseeing such endpoint device without undue delay or misdirected routing), thus reducing the amount of network resources, such as processing resources, storage resources, network resources, and/or the like, that are being used, (ii) providing a more accurate solution to problem, thus reducing the number of resources required to remedy any errors made due to a less accurate solution (e.g., by eliminating re-routing of events that would otherwise occur if routing of events was to the improper group of endpoint devices), (iii) removing manual input and waste from the implementation of the solution, thus improving speed and efficiency of the process and conserving network resources (e.g., eliminating the need to manually respond to multiple events that refer to the same underlying problem, and instead only respond to one), (iv) determining an optimal amount of resources that need to be used to implement the solution, thus reducing network traffic and load on existing network resources (e.g., use machine learning algorithms to dynamically adjust the number of processing nodes and filtering criteria, thereby reducing redundant alerts and minimizing network traffic and load on existing resources). In other words, the solution may bypass a series of steps previously implemented, thus further conserving network resources. Furthermore, the technical solution described herein uses a rigorous, computerized process to perform specific tasks and/or activities that were not previously performed.

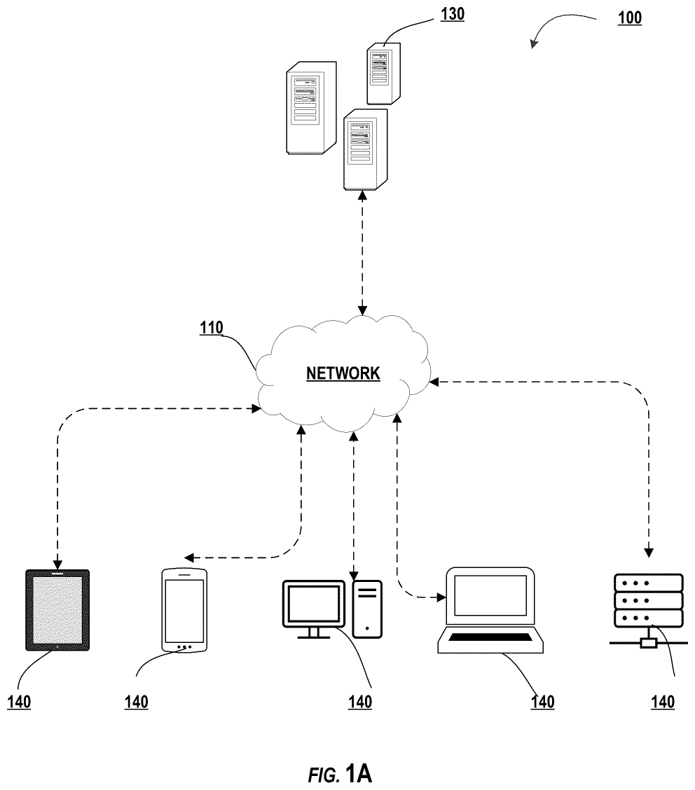

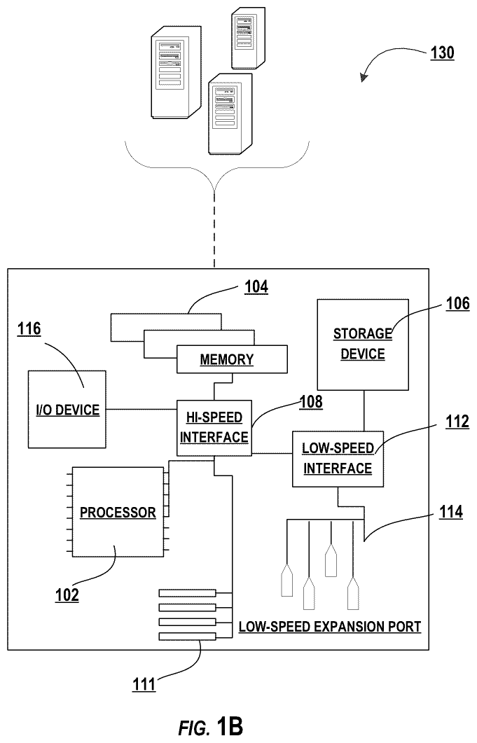

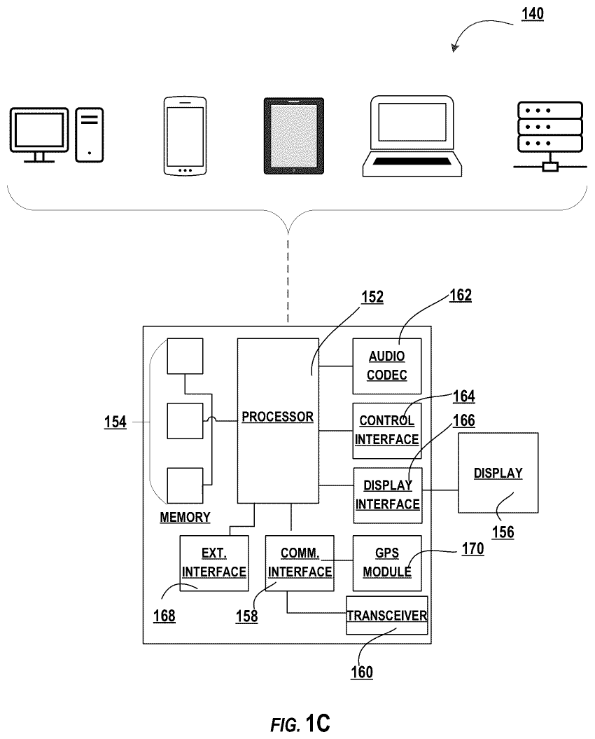

FIGS. 1A-1C illustrate technical components of an exemplary distributed computing environment 100 for computer network event data redundancy suppression via integrated machine learning, in accordance with an implementation of the disclosure. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an implementation of the distributed computing environment 100, and it will be appreciated that in other implementations one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some implementations, the system 130 and the endpoint device(s) 140 may have a client-server relationship in which the endpoint device(s) 140 are remote devices that request and receive application from a centralized server, i.e., the system 130. In some other implementations, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The endpoint device(s) 140 may represent various forms of electronic devices, including user input devices such as personal digital assistants, cellular telephones, smartphones, laptops, desktops, and/or the like, input devices such as resource transfer terminals, electronic resource transfer units, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an implementation of the disclosure. As shown in FIG. 1B, the system 130 may include a processing device 102, memory 104, input/output (I/O) device 116, and a storage device 106. The system 130 may also include a high-speed interface 108 connecting to the memory 104, and a low-speed interface 112 connecting to a low-speed bus 114 and a storage device 106. Each of the components 102, 104, 108, 110, and 112 may be operatively coupled to one another using various buses and may be mounted on a common motherboard or in other manners as appropriate. As described herein, the processing device 102 may include a number of subsystems to execute the portions of processes described herein. Each subsystem may be a self-contained component of a larger system (e.g., system 130) and capable of being configured to execute specialized processes as part of the larger system.

The processing device 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processing devices, along with multiple memories, and/or I/O devices, to execute the processes described herein. In other words, as used herein, a “processing device” means one processing device (e.g., a microprocessor) that performs the defined functions or a plurality of processing devices (e.g., microprocessors) that collectively perform defined functions such that the execution of the individual defined functions may be divided amongst such processing devices.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly implemented in an information carrier. The computer program product may also contain instructions that, when executed, perform one or more methods, such as those described above. The information carrier may be a non-transitory computer- or machine-readable storage medium, such as the memory 104, the storage device 106, or memory on processing device 102.

The high-speed interface 108 manages bandwidth-intensive operations for the system 130, while the low-speed controller 112 manages lower bandwidth-intensive operations. Such allocation of functions is exemplary only. In some implementations, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with an implementation of the disclosure. As shown in FIG. 1C, the endpoint device(s) 140 includes a processing device 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processing device 152 is configured to execute instructions within the endpoint device(s) 140, including instructions stored in the memory 154, which in one implementation includes the instructions of an application that may perform the functions disclosed herein, including certain logic, data processing, and data storing functions. The processing device may be implemented as a chipset of chips that include separate and multiple analog and digital processors. The processing device may be configured to provide, for example, for coordination of the other components of the endpoint device(s) 140, such as control of user interfaces, applications run by endpoint device(s) 140, and wireless communication by endpoint device(s) 140.

The processing device 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processing device 152. In addition, an external interface 168 may be provided in communication with processing device 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a SIMM (Single In Line Memory Module) card interface. Such expansion memory may provide extra storage space for endpoint device(s) 140 or may also store applications or other information therein. In some implementations, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly implemented in an information carrier. The computer program product contains instructions that, when executed, perform one or more methods, such as those described herein. The information carrier is a computer- or machine-readable medium, such as the memory 154, expansion memory, memory on processing device 152, or a propagated signal that may be received, for example, over transceiver 160 or external interface 168.

In some implementations, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to endpoint device(s) 140, which may be used as appropriate by applications running thereon, and in some implementations, one or more applications operating on the system 130.

The endpoint device(s) 140 may also communicate audibly using audio codec 162, which may receive spoken information from a user and convert the spoken information to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some implementations, one or more applications operating on the system 130.

Various implementations of the distributed computing environment 100, including the system 130 and endpoint device(s) 140, and techniques described here can be realized in digital electronic circuitry, integrated circuitry, specially designed ASICs (application specific integrated circuits), computer hardware, firmware, software, and/or combinations thereof.

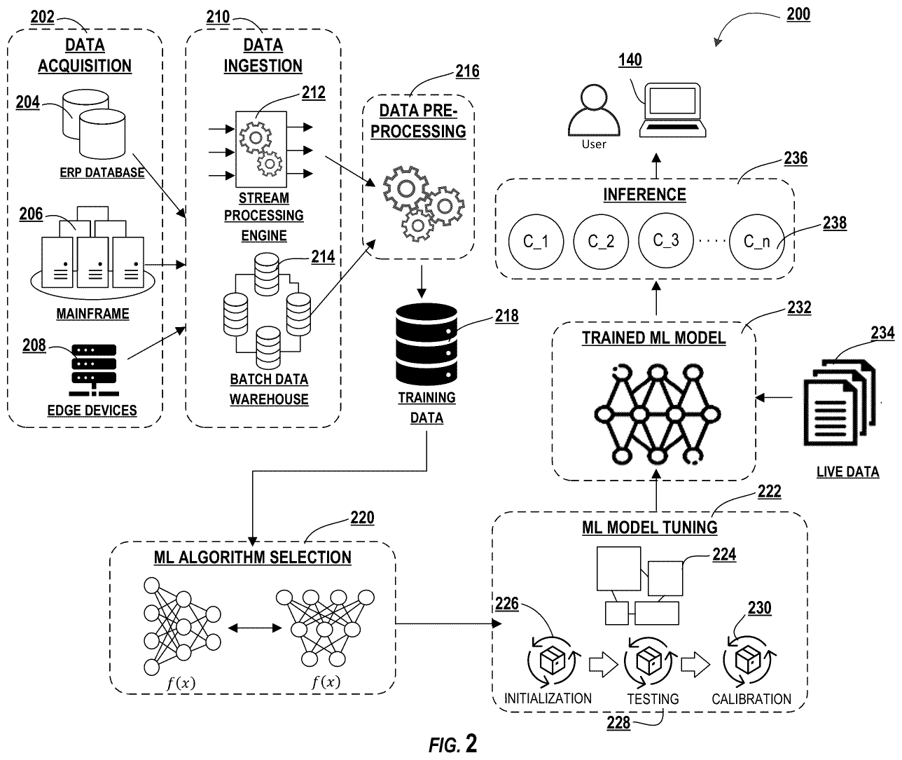

FIG. 2 illustrates an exemplary machine learning model subsystem architecture 200, in accordance with an implementation of the disclosure. The machine learning subsystem 200 may include a data acquisition engine 202, data ingestion engine 210, data pre-processing engine 316, machine learning model tuning engine 222, and inference engine 236.

The data acquisition engine 202 may identify various internal and/or external data sources to generate, test, and/or integrate new features for training the machine learning model. These internal and/or external data sources 204, 206, and 208 may be initial locations where the data originates or where physical information is first digitized. The data acquisition engine 202 may identify the location of the data and describe connection characteristics for access and retrieval of data. In some implementations, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other applications. In some implementations, the these data sources 204, 206, and 208 may include Enterprise Resource Planning (ERP) databases or protocol databases that host data related to day-to-day enterprise activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of network resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points. As will be understood in view of the present disclosure, training data 218 may additionally, or alternatively, be provided from a third party, having been generated as synthetic data.

The machine learning model tuning engine 222 may be used to train a machine learning model to form a trained machine learning model 232 using the training data 218 to make predictions or decisions without explicitly being programmed to do so. The machine learning model 232 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms can adjust their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the machine learning model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the machine learning model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical enterprise decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It shall be understood that the implementation of the machine learning subsystem 200 illustrated in FIG. 2 is exemplary and that other implementations may vary. As another example, in some implementations, the machine learning subsystem 200 may include more, fewer, or different components.

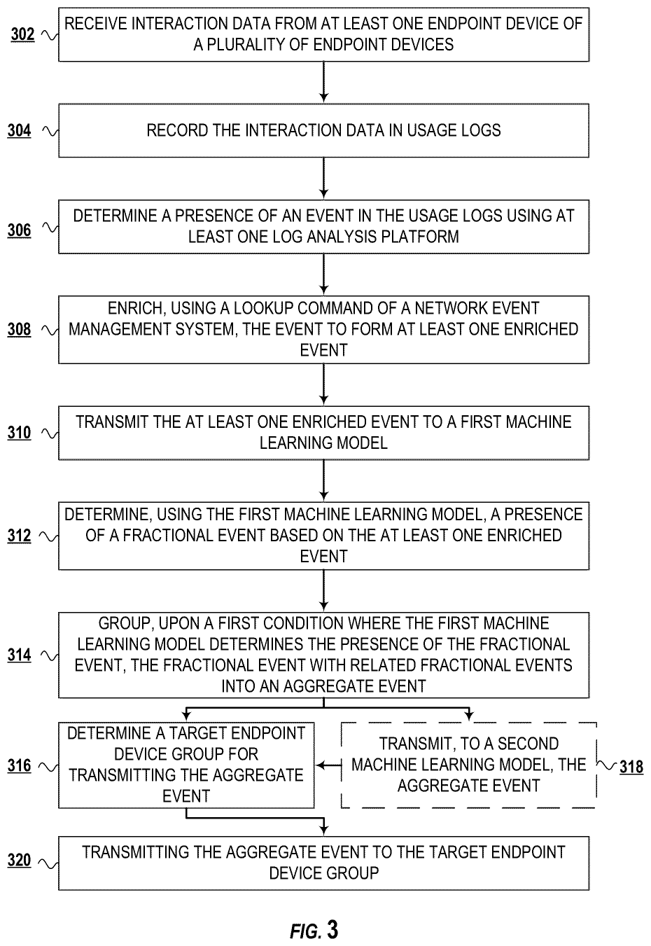

FIG. 3 illustrates a process flow for computer network event data redundancy suppression via integrated machine learning, in accordance with an implementation of the disclosure. At block 302, the system 130 may receive interaction data from at least one endpoint device 140 of a plurality of endpoint devices. The interaction data may be collected from numerous sources within the computing network system, including log data from servers, applications, network devices, and endpoints, such as system logs, application logs, security logs, and audit trails, event-based data generated by user activities, like login attempts, file access, and database queries, network data, including packet captures, firewall logs, and logs from network devices like routers and switches, transactional records from financial systems and e-commerce audit trails, machine data, data sourced from Internet of Things (IoT) devices and sensors, web server logs, clickstream data, user activity, or the like.

Next, at block 304, the system 130 may record the interaction data in usage logs as the system 130 collects this interaction data. In some implementations, interaction data may be recorded in the usage logs in delimited text format, such as CSV (Comma-Separated Values). In such implementations, interaction data may be recorded in rows, with each field separated by a delimiter like a comma or tab. Each row may represent a single interaction, and the columns contain fixed fields such as time, user ID, action, and result. Each log entry may conform to a predefined schema.

In other implementations, interaction data may be recorded in usage logs as a structured format like JSON (JavaScript Object Notation). In these implementations, the log entries may be organized in key-value pairs to allow for a flexible and readable structure. Each interaction may be logged with defined attributes such as timestamps, user IDs, actions performed, and system responses.

In some implementations, the unstructured interaction data (e.g., CSV) may be transformed into structured interaction data (e.g., JSON). For example, the CSV file may first be parsed to read the data, with each row representing an individual interaction and each column corresponding to a specific field, such as a timestamp, user ID, or event type. Next, the headers of the CSV file may be mapped as keys in the JSON format, while the values of each row may be assigned to the corresponding keys to generate a structured JSON object for each row, which keeps key-value relationships clearly defined. If the CSV includes nested or complex data, additional processing may be required to convert these fields into nested JSON objects. Finally, data cleaning or normalization steps may be applied, such as handling missing values or correcting inconsistent formats.

In some implementations, the interaction data is being received in real-time, as a stream of interaction data (i.e., an “interaction data stream”). Accordingly, the interaction data may be recorded in the usage logs in real-time. Thus, the subsequent steps of the process describes herein may similarly occur in real-time by analyzing incoming or queued (e.g., in a buffer) interaction data from the usage logs.

For example, in some implementations, real-time data storage and processing may be achieved through streaming platforms that allow interaction data to be ingested as soon as it is generated. These systems may consume the interaction data from the usage logs by real-time processing engines. The interaction data may be broken into small batches.

Additionally, or alternatively, data may be queued in real-time before being processed, either for immediate or later analysis. Interaction data may be placed in a queue, acting as a buffer that prevents data loss during peak loads. This queued data may then be consumed by real-time analysis services or stored for retrospective processing. The queuing system may allow for continuous data intake while balancing processing demands.

Additionally, or alternatively, batch processing may be used for retrospective analysis by storing interaction data in a database or data storage system. After the interaction data accumulates over a period, it may be processed in larger chunks using batch analysis engines designed for historical data. Alternatively, a hybrid system may combine real-time and batch processing to allow for interaction data to be analyzed in real-time while also being stored for future retrospective analysis.

Continuing at block 306, the system 130 may determine a presence of an event in the usage logs using at least one log analysis platform. The log analysis platform may receive the interaction data from the usage logs and index the interaction data, where the log analysis platform may parse and organize the interaction data into a searchable format if it hasn't already been structured. The log analysis platform may provide real-time monitoring by continuously collecting and indexing incoming interaction data, and triggering alerts or automated responses when predefined conditions are met.

An event may be determined by the log analysis platform by extracting relevant fields, timestamps, and metadata, in response to predetermined conditions specified. The interaction data may be filtered and aggregated to isolate specific occurrences in the interaction data based on predetermined criteria.

As one non-limiting example, predetermined criteria could involve monitoring a web server for potential security breaches. Predetermined criteria may be set to identify events where there are more than 100 failed login attempts within a five-minute window, which would be indicative of a potential brute-force malfeasant operation. This criteria may include searching for specific usage log entries that indicate failed authentications and filtering by IP address to identify repeated attempts from the same source. The system 130 would monitor for these conditions in real-time and, when the criteria are met, label the associated data as an “event.”

However, relying solely on a log analysis platform that detects events based on predetermined criteria is deficient in several ways. Notably, the log analysis platform may lack the context needed to fully understand the significance of an event. In doing so, false positives or false negatives may result. For example, while the system 130 may detect a high number of failed login attempts, it may not distinguish between benign activity (e.g., login attempts from a single location) and that which is malicious (e.g., login attempts from numerous geographical locations). As such, there may be a need to enrich the event identified by the log analysis platform, as will be discussed in greater detail with respect to block 308.

In some implementations, the at least one log analysis platform is a plurality of log analysis platforms. It shall be appreciated that large enterprises with complex IT infrastructures, multiple log analysis platforms may be used together to address different aspects of data monitoring, security, and analytics, since some may perform better than others depending on the use-case and capabilities.

For example, one log analysis platform may perform log aggregation and search, while another log analysis platform performs metrics collection such as time-series data from specific environments. In another example, a combination of log analysis platforms may address both deep log analysis and real-time infrastructure monitoring, particularly for cloud applications. In another example, one log analysis platform may manage on-premise data and another log analysis platform may handle cloud-based log management and security analytics. In another example, one log analysis platform may track application layer performance while another focuses on log analysis and problem-solving.

Next, at block 308, the system 130 may enrich the event to form at least one enriched event. The enriching of an event may be performed by a network event management system, using a lookup command of the network event management system. The network event management system may implement SQL queries or other lookup mechanisms to fetch values from predefined tables such as to retrieve information from one or more external sources (e.g., database), these values to be used for enriching the event.

For example, a lookup table may store physical locations for various endpoint devices, such that when an event includes an endpoint device ID or IP address, a lookup by the network event management system can enrich the event by providing the specific location details, such as “New York Data Center, Rack 33, Row 29.” Additionally, or alternatively, raw severity codes in events can be automatically mapped to predetermined human-readable severity levels, such as a code 5 translating to “Critical” to prioritize response actions.

A lookup table may also allow for adding vendor-specific information. For example, when an event is triggered by a particular endpoint device 140, a lookup can pull the associated vendor name and model. Lookup tables can also help in determining which services might be impacted by a specific failure. For example, an event involving Router123 can automatically link to the affected service.

Additionally, or alternatively, maintenance schedules for devices can be stored in lookup tables such that during an event, the lookup command can determine if the device is currently under a maintenance window. If a device is within a scheduled maintenance period, this information can be appended to the event.

Additionally, lookup tables may be used to reference known incidents or problem records. For example, if a firewall triggers an event, a lookup can flag it as having a known software issue. Additionally, or alternatively, lookup tables may be used for IP-to-hostname resolution to map IP addresses to a corresponding hostname.

Additionally, or alternatively, lookup tables may be used to assign endpoint device ownership based on event type or device criticality. For example, an event for device 192.168.1.35 might be enriched with information that it is managed by “IT Operations, Department XYZ.” In doing so, escalation may allow for escalation to the correct department.

In some implementations, enriching the event may include temporal correlation and rule-based filtering. Temporal correlation and rule-based filtering may be performed by the network event management system. Temporal correlation identifies patterns in the occurrence of events over a predefined period. For example, if an event type exceeds a predefined threshold of frequency within a specific time window, the system may correlate these repeated occurrences into a single alert. Additionally, or alternatively, predefined categories of event sequences may be used to detect specific patterns and treat them as a single correlated event. Rule-based filtering may use predefined categories and predetermined thresholds to filter out irrelevant or low-fractional events. Events that do not meet the established severity or frequency criteria may be automatically suppressed. For example, if a device generates a warning that falls below a predefined threshold for action, that event may be filtered out.

Despite event enriching, temporal correlation, and/or rule-based filtering, redundant and repetitive events may exist at the output of the network event management system. For example, events between two endpoint devices of the same user may be detected, but not correlated with each other in the network event management system. Despite a common mode of failure (e.g., a local network blackout, etc.) and a common solution to said failure (e.g., resetting the local network), traditional systems may pass both events to one or more endpoint devices 140 of a user group for rectification. In doing so, endpoint devices within a user group may be overloaded with alerts associated with events, ultimately leading to the inability to prioritize high fractional events over an onslaught of lower fractional events.

Accordingly, at block 310, the system 130 may transmit the at least one enriched event to a first machine learning model (e.g., machine learning model 232). The purpose of the first machine learning model may be to receive the at least one enriched event from the output of the network event management system and determine if the at least one enriched event is relates to any other enriched events previously received, or any other group of events (“aggregate events”).

Continuing at block 312, the system 130 may determine, using the first machine learning model, a presence of a fractional event based on the at least one enriched event. The first machine learning model may ingest the at least one enriched event, and thereafter determine if other enriched events received by the first machine learning model are related thereto. If it has been determined that one or more enriched events are related to other enriched events, these enriched events may then be referred to herein as “fractional event(s),” such that the fractional event(s) are a portion of a broader “aggregate event.” Events that the system is unable to correlate with other related events still remain in the system as “enriched events” such that future enriched events received by the first machine learning model may be associated therewith.

Both aggregate events and enriched events may still be “pending” within the system 130, such that no disposition has taken place yet. For example, an aggregate event may remain open to receiving additional fractional events related thereto, having not yet been communicated to users or endpoint devices within the entity for resolution of the underlying issue. These aggregated events may be pending until a predetermined number of fractional events have joined the aggregated event, or a predetermined amount of time has passed, or the like. As another example, enriched events may be solitary, such that no other enriched events have been determined to be associated therewith by the first machine learning model. These enriched events may be pending until joined with other enriched events to form an aggregate event, a predetermined amount of time has passed, a predetermined number of fractional events have joined the ensuing aggregated event, or the like.

In some implementations, the first machine learning model may implement clustering algorithms (e.g., unsupervised machine learning) to determine if an incoming enriched event relates to any pending aggregate events or any pending enriched events. As non-limiting examples, a K-means clustering algorithm may be implemented, DBSCAN, Hierarchical clustering, or the like. The enriched event may be received and may undergo formatting or structuring to match pending aggregate events or any pending enriched events.

Missing values may be removed or completed, features may be normalized or standardized, or other pre-processing of the enriched events. A predetermined number of clusters may be determined, or parameters may be set such as the epsilon number or the number of samples in a neighborhood for a point to be considered a core point, if DBSCAN clustering is implemented. The clustering model is then applied to the pending aggregate events or any pending enriched events, along with the incoming enriched event, which will group similar events together. The system 130 may then identify clusters to which the incoming enriched event is grouped, and infer that the events are related (e.g., that the incoming enriched event is a fractional event of a pending aggregate event or any pending enriched event), which may be accomplished using scoring methods such as silhouette scoring or adjusted rand index.

Additionally, or alternatively, the first machine learning model may implement natural language processing. Prior to any clustering algorithm being applied to the incoming enriched event, natural language processing may be implemented, where the incoming enriched event may be tokenized by individual words or tokens. “Stop words” may be removed, and words may be reduced to their base form if necessary. Thereafter, one or more natural language processing methods may be used to extract the meaningful features of the text of the incoming enriched event via vectorization (e.g., bag-of-words, term frequency-inverse document frequency, word embeddings, or the like). Thereafter, the processed words may be used in the previously-described clustering algorithms to infer similarity.

Additionally, or alternatively, the first machine learning model may implement graph based adaptive filtering.

At block 314, the system 130 may group what has now been deemed as a “fractional event” with other related factional events as determined by the first machine learning model. This grouping results in the “aggregate event.”

In some implementations, the aggregate event may be a single event “ticket” that lists details (e.g., event identifier, user identifier(s), endpoint device identifier(s), timestamp(s), connection state changes, data transfer metrics, data transfer protocols used such as TCP/IP or HTTP, IP address(es), MAC address(es), user activity leading to the event, application(s) used, error code(s), or the like) of each of that fractional events (e.g., related fractional events) within the aggregate event. In other implementations, the aggregate event may be a single event “ticket” that is generated by the first machine learning model that lists details common between the related events within the aggregate event. For example, details such as event identifier, user identifier(s), endpoint device identifier(s), timestamp(s), connection state changes, data transfer metrics, data transfer protocols used such as TCP/IP or HTTP, IP address(es), MAC address(es), user activity leading to the event, application(s) used, error code(s), or the like. Additionally, or alternatively, the aggregate event may be a single event “ticket” having one or more summaries for these various details generated as an output of a machine learning model (e.g., the first machine learning model, a second machine learning model, or the like), as a generative output predicting commonalities between the aggregate events that formed the aggregate event.

In some implementations, the machine learning model may include with the aggregate event a prediction of the underlying issue causing each of the underlying fractional events to generate such events, such that the underlying issue can be used for resolving whatever issue may be ongoing.

In some implementations, the fractional event and the related fractional events are removed in favor of the aggregate event. In other words, to free up computing resources, dashboards containing event listings, or the like, the system 130 may delete the fractional event(s) (including related fractional events) once the aggregate event has been generated. In doing so, only the aggregate event remains, but the aggregate event contains the most crucial details of the event necessary for resolving the underlying issue.

In some implementations, the process may continue at block 316, where the system 130 may determine a target endpoint device group for transmitting the aggregate event. It shall be appreciated that entities may have predetermined endpoint device groups associated with users who are best trained and skilled to resolve an underlying issue. Additionally, or alternatively, entities may have endpoint device groups with specialized permissions, such that endpoint devices within certain endpoint device groups are required to resolve an underlying issue. In any instance, transmitting the aggregate event to the appropriate endpoint device group may be critical for resolving an underlying issue in a timely and efficient manner.

In some implementations, a lookup table may exist such that aggregate events that have certain underlying issues are associated with predetermined endpoint device group(s). A predetermined characteristic of the aggregate event may be used along with the lookup table to determine the endpoint device group(s) to which to send the aggregate event. For example, the system 130 may look at the IP address(es) of the aggregate event, and use the IP address(es) with the lookup table to identify the “target” endpoint device group(s) that should receive the aggregate event. Other predetermined characteristics are also considered, including the line of business with which the aggregate event (and therefore its underlying fractional events) is associated, the time zone of the aggregate event, the timespan during which events underlying the aggregate event occurred, the type of device that led to the events underlying the aggregate event, and so forth.

In other implementations, the system 130 may transmit, to a second machine learning model (e.g., machine learning model 232), the aggregate event, and use the second machine learning model to determine the target endpoint device group. While lookup tables may be one method for determining the endpoint device group, a second machine learning model may be implemented to predict which endpoint device group is ideal, a machine learning model may provide for a dynamic approach. For example, the second machine learning model may infer based on the time required for resolving underlying issues in the past (based on the time data of past data of resolving aggregate events) that certain endpoint device groups could resolve the underlying issue more quickly. As such, the second machine learning model may identify said endpoint device group (as a “target endpoint device group”) for transmitting thereto in subsequent steps.

To do so, the second machine learning model may be trained using labeled datasets of endpoint device groups and aggregate events transmitted thereto, and in some implementations along with feedback via supervised learning (i.e., supervised training) as to whether the transmission of the aggregate events to said endpoint device groups was deemed effective or not.

Naturally, the process may continue at block 320, where the system 130 transmits the aggregate event to the target endpoint device group. In doing so, the aggregate event (often in the form of a “ticket”) may be provided to the target endpoint device group. This may occur when a predetermined number of fractional events have joined the aggregated event, a predetermined amount of time has passed, or the like.

In some implementations, the transmitting of the aggregate event ticket in block 320 may occur simultaneously with the determination of a target endpoint device group for transmitting the aggregate event in block 318.

In some implementations, the target endpoint device group may be a single endpoint device 140. In other implementations, the target endpoint device group may be a plurality of endpoint devices 140.

In some implementations, the aggregate event may include a notification including aggregate event details that may be caused to be displayed by the system 130. For example, upon receipt of the aggregate event at the target endpoint device group, the system 130 may transmit a generated a notification to the endpoint device(s) of the target endpoint device group. The notification may take the form of a pop-up notification, email, SMS message, phone call, or the like. The notification may contain aggregate event details, including, for example, a summary of the aggregate event, a characteristic of the aggregate event such as IP address(es) of the aggregate event, the line of business with which the aggregate event is associated, the time zone of the aggregate event, the timespan during which events underlying the aggregate event occurred, the type of device that led to the events underlying the aggregate event, and so forth.

In some implementations, the code further causes the apparatus to suppress, in real time, a subsequent fractional event upon a condition where the aggregate event associated with the subsequent fractional event has been transmitted to the target endpoint device group.

It shall be appreciated that interaction data, events identified therefrom, and corresponding fractional and aggregate events may be actively ongoing, such that an underlying issue has yet to be resolved. However, an aggregate event associated with the underlying issue may have already been transmitted to the target endpoint device group. As such, further aggregate events generated as a result of the processes described herein may be duplicative, repetitive, or otherwise unnecessary in order for the target endpoint device group to be aware of the ongoing underlying issue. Accordingly, in some implementations, as the system 130 receives subsequent fractional events in real time, these subsequent fractional events may be suppressed such that an aggregate event is not able to be generated. To do so, the system 130 may maintain an aggregate event log to record details of the aggregate events transmitted to any endpoint device group within a predetermined window of time in the past.

As fractional events are determined (e.g., in block 312), details (e.g., IP addresses, endpoint device type, location, or the like) are compared not only to pending aggregate events (i.e., not yet transmitted/communicated to an endpoint device group), but also to the aggregate events in the aggregate event log. In some implementations, the fractional event may be suppressed (i.e., ignored, and not used subsequently to form an aggregate event) upon a condition where a predetermined percentage of words of the fractional event match a single entry within the aggregate event log. This may be accomplished via parsing the fractional event and aggregate event log.

In other implementations, the comparison of the fractional event to the aggregate events in the aggregate event log may be accomplished using an additional machine learning model (e.g., a third or fourth machine learning model) to engage with the fractional event and the aggregate event log via natural language processing. In implementations where a machine learning model is implemented, clustering (as previously described in detail herein) may be implemented to determine if aggregate events in the aggregate event log are similar to the fractional event.

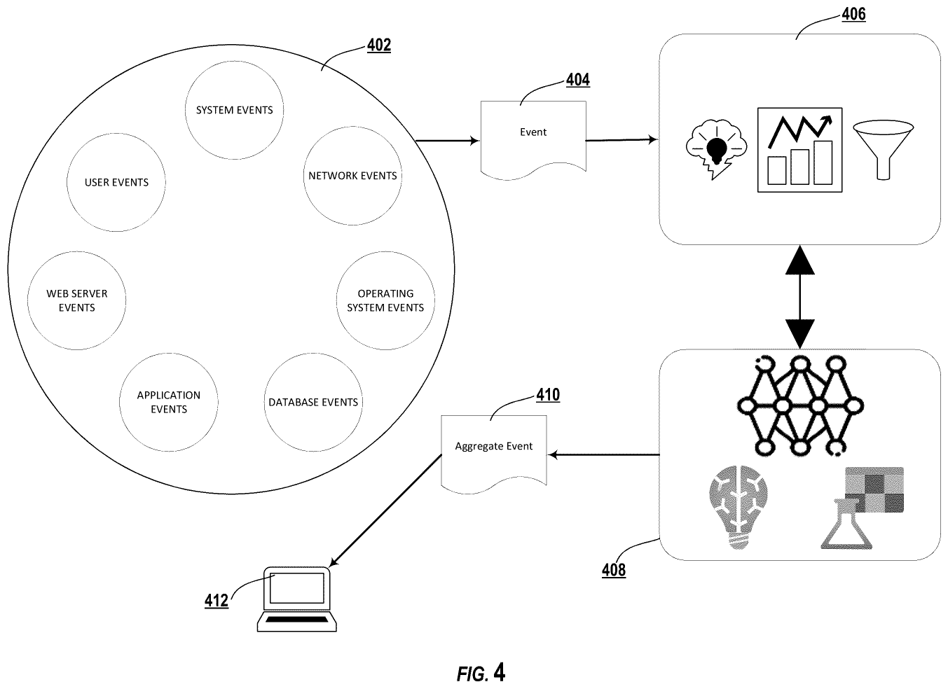

FIG. 4 illustrates a flow diagram for computer network event data redundancy suppression via integrated machine learning, in accordance with an implementation of the disclosure. Interaction data 402 may be received, and in turn at least one event 404 may be inferred based on the interaction data 402. A network event management system 406 may receive the event 404, where an enriched event is generated. The machine learning model 408 may receive the enriched event, where it is determined whether the enriched event is a fractional event belonging to a larger underlying issue that is expressed through other (related) fractional events already. If so, the fractional event may be combined with related fractional events to form the aggregated event 410, which may then transmitted to the target endpoint device group 412.

As will be appreciated by one of ordinary skill in the art, the present disclosure may be implemented as an apparatus (including, for example, a system, a machine, a device, a computer program product, and/or the like), as a method (including, for example, an enterprise process, a computer-implemented process, and/or the like), as a computer program product (including firmware, resident software, micro-code, and the like), or as any combination of the foregoing. Many modifications and other implementations of the present disclosure set forth herein will come to mind to one skilled in the art to which these implementations pertain having the benefit of the teachings presented in the foregoing descriptions and the associated drawings. Although the Figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for computer network event data redundancy suppression via integrated machine learning, the system comprising:
a processing device; and
a non-transitory storage device containing instructions, when executed by the processing device, the instructions cause the processing device to perform the steps of:
receiving interaction data from at least one endpoint device of a plurality of endpoint devices;
recording the interaction data in usage logs;
determining a presence of an event in the usage logs using at least one log analysis platform;
enriching, using a lookup command of a network event management system, the event to form at least one enriched event;
transmitting the at least one enriched event to a first machine learning model;
determining, in real-time, using the first machine learning model, a presence of a fractional event based on the at least one enriched event;
grouping, in real-time, upon a first condition where the first machine learning model determines the presence of the fractional event, the fractional event with related fractional events into an aggregate event;
determining a target endpoint device group for transmitting the aggregate event; and
transmitting the aggregate event to the target endpoint device group.

2. The system of claim 1, wherein the instructions further cause the processing device to perform the steps of:
transmitting, to a second machine learning model, the aggregate event; and
determining, using the second machine learning model, the target endpoint device group.

3. The system of claim 1, wherein the fractional event and the related fractional events are removed in favor of the aggregate event.

4. The system of claim 1, wherein enriching the event comprises temporal correlation and rule-based filtering.

5. The system of claim 1, wherein the at least one log analysis platform is a plurality of log analysis platforms.

6. The system of claim 1, wherein the aggregate event comprises a notification comprising aggregate event details.

7. The system of claim 1, wherein the instructions further cause the processing device to perform the steps of:
suppressing, in real time, a subsequent fractional event upon a condition where the aggregate event associated with the subsequent fractional event has been transmitted to the target endpoint device group.

8. A computer program product for computer network event data redundancy suppression via integrated machine learning, the computer program product comprising a non-transitory computer-readable medium comprising code causing an apparatus to:
receive interaction data from at least one endpoint device of a plurality of endpoint devices;
record the interaction data in usage logs;
determine a presence of an event in the usage logs using at least one log analysis platform;
enrich, using a lookup command of a network event management system, the event to form at least one enriched event;
transmit the at least one enriched event to a first machine learning model;
determine, using the first machine learning model, a presence of a fractional event based on the at least one enriched event;
group, upon a first condition where the first machine learning model determines the presence of the fractional event, the fractional event with related fractional events into an aggregate event;
determine a target endpoint device group for transmitting the aggregate event; and
transmit the aggregate event to the target endpoint device group.

9. The computer program product of claim 8, wherein the code further causes the apparatus to:
transmit, to a second machine learning model, the aggregate event; and
determine, using the second machine learning model, the target endpoint device group.

10. The computer program product of claim 8, wherein the fractional event and the related fractional events are removed in favor of the aggregate event.

11. The computer program product of claim 8, wherein enriching the event comprises temporal correlation and rule-based filtering.

12. The computer program product of claim 8, wherein the at least one log analysis platform is a plurality of log analysis platforms.

13. The computer program product of claim 8, wherein the aggregate event comprises a notification comprising aggregate event details.

14. The computer program product of claim 8, wherein the code further causes the apparatus to:
suppress, in real time, a subsequent fractional event upon a condition where the aggregate event associated with the subsequent fractional event has been transmitted to the target endpoint device group.

15. A method for computer network event data redundancy suppression via integrated machine learning, the method comprising:
receiving interaction data from at least one endpoint device of a plurality of endpoint devices;
recording the interaction data in usage logs;
determining a presence of an event in the usage logs using at least one log analysis platform;
enriching, using a lookup command of a network event management system, the event to form at least one enriched event;
transmitting the at least one enriched event to a first machine learning model;
determining, using the first machine learning model, a presence of a fractional event based on the at least one enriched event;
grouping, upon a first condition where the first machine learning model determines the presence of the fractional event, the fractional event with related fractional events into an aggregate event;
determining a target endpoint device group for transmitting the aggregate event; and
transmitting the aggregate event to the target endpoint device group.

16. The method of claim 15, the method further comprising:
transmitting, to a second machine learning model, the aggregate event; and
determining, using the second machine learning model, the target endpoint device group.

17. The method of claim 15, wherein the fractional event and the related fractional events are removed in favor of the aggregate event.

18. The method of claim 15, wherein enriching the event comprises temporal correlation and rule-based filtering.

19. The method of claim 15, wherein the at least one log analysis platform is a plurality of log analysis platforms.

20. The method of claim 15, wherein the aggregate event comprises a notification comprising aggregate event details.
